(19) United States
(12) Patent Application Publication
(10) Pub. No.: US 2014/0221073 A1
(43) Pub. Date: Aug. 7, 2014

(54) BINGO GAME SYSTEM WITH WHEEL GAME SIMULATION FEATURE

(71) Applicant: Pockaj D.O.O. (d/b/a Alfastreet), Kozina (SI)

(72) Inventor: Iztok Pockaj, Lokev (SI)

(73) Assignee: Pockaj D.O.O. (d/b/a Alfastreet), Kozina (SI)

(21) Appl. No.: 14/196,772

(22) Filed: Mar. 4, 2014

Related U.S. Application Data
(63) Continuation-in-part of application No. 14/171,542, filed on Feb. 3, 2014.
(60) Provisional application No. 61/759,724, filed on Feb. 1, 2013.
(60) Provisional application No. 61/806,694, filed on Mar. 29, 2013.
(60) Provisional application No. 61/773,058, filed on Mar. 5, 2013.

(51) Int. Cl. G07F 17/32

(52) U.S. Cl. CPC G07F 17/3286
USPC 463/19

(57) ABSTRACT

A bingo game system with a wheel game simulation feature including a wheel divided into a plurality of sections, wherein each section is associated with a wheel game outcome, and a processing device for facilitating the steps of assigning one or more unique numbers from a pool of bingo numbers to each section of the wheel game simulation feature, randomly drawing numbers from the pool of bingo numbers, determining if the randomly drawn numbers include the one or more unique numbers assigned to one of the sections of the wheel; responsive to the determination that the one or more unique numbers assigned to one of the sections of the wheel has been randomly drawn, actuating the wheel game simulation feature to simulate the operation and conclusion of a wheel game in which the section assigned to the one or more unique numbers is identified as the game outcome.

### CROSS REFERENCE TO RELATED APPLICATIONS

This application claims priority to U.S. Non-Provisional application No. 14/171,542 filed on Feb. 3, 2014, which claims priority to U.S. Provisional Application No. 61/759,724 filed on Feb. 1, 2013, U.S. Provisional Application No. 61/806,694 filed on Mar. 29, 2013, and U.S. Provisional Application No. 61/773,058 filed on Mar. 5, 2013, the entireties of which are incorporated herein by reference.

### COPYRIGHT NOTICE

A portion of this disclosure contains material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### BACKGROUND

The invention is directed to wagering games, and more particularly, playing bingo-type games. The invention also generally relates to systems and methods for playing bingo-type games. More specifically, the invention relates to systems and methods for playing a bingo game that incorporates a different game paradigm and game outcome display, such as the paradigm of a mechanical game outcome determining device.

Bingo-type games are known in the art. For example, as is known, a traditional bingo game is played with bingo cards or tickets, which typically have a 5×5 grid. More specifically, this grid includes 5 columns and 5 rows, and the letters, “B,” “I,” “N,” “G,” and “O” are at the top of each column. Under each letter are five numbers, with the exception of the center space which is typically a free space. Therefore, there are typically 24 numbers. The numbers on the each bingo card are randomly established so that each bingo card is unique. The bingo cards further include a predetermined pattern or patterns, which are typically represented by a darkened segment in the traditional bingo game. Numbers are called, e.g. “I-20”, and players of the game daub, or otherwise, mark-off the number if they have it. Once a player achieves the predetermined pattern or patterns, and the player actually recognizes this achievement, he or she wins and the game is over.

Other bingo-type games include modern variations of the traditional bingo-type game. Some of these modern variations are played in a casino or gaming hall at a client, i.e., terminal. The client is also referred to as an electronic play station. These modern variations have various attractions and designs, including aesthetic symbols and both audio and visual animations, to attract players thereby increasing a level of play. As discussed above, these modern variations are bingo-type games. However, there is recognition throughout industry that players of even the modern bingo-type games do not consider these games as exciting and attractive as standard gaming options, such as those offered at Las Vegas-style casinos which permit slots, roulette, craps, wheel games, such as the Big Six wheel or other wheel games, and poker. Simply stated, the bingo-type games do not look and operate like these games. For this reason, the bingo-type games are not as appealing to patrons, which impacts the level of play as compared to that of the standard gaming options and is therefore less desirable to both the industry and players.

To this end, there have been efforts to maintain a bingo-type game, if required to do so by law, yet still create the ‘appearance’ of another game. These efforts have generally focused on making the bingo-type game appear as a standard slot machine by displaying a representation of a result of the bingo-type game, i.e., whether a player has won or lost, through a slot outcome. Therefore, although the player is playing the bingo-type game, and any payouts to the player are based on this bingo-type game, the player views one of an almost unlimited amount of slot machine outcomes as if it had been determined by the slot machine while the outcome displayed actually is a representation of the bingo-type game outcome.

Gaming establishments or casinos continually require new games to offer their players. It is therefore desirable to provide a new and unique bingo-type game that creates the perception of a wheel type game rather than a slot machine, to heighten interest of the patrons that desire to play such wheel games, such as the Big Six wheel or other bonus wheel games, in establishments that may only be able to offer bingo-type games. Naturally, casino operators seek to provide popular games for their gaming patrons.

Thus, there is a need for systems and methods which resolve one or more of the problems identified above, among other things.

### SUMMARY OF INVENTION

Some embodiments of the invention are directed to a bingo game system with a wheel game simulation feature comprising: one or more game stations, each playing station configured to accept a wager; a wheel game simulation feature including a wheel mounted for rotational motion having a circular face divided into a plurality of sections, wherein each section is associated with a wheel game outcome; and a game controller.

In some embodiments, the game controller is configured to: receive a wager through the one or more game stations; assign one or more unique numbers from a pool of bingo numbers to each section of the plurality of sections of the wheel, wherein each section is associated with a possible game outcome; randomly draw numbers from the pool of bingo numbers; determine if the randomly drawn numbers include the one or more unique numbers assigned to a section; responsive to the determination that the one or more unique numbers assigned to a section has been randomly drawn, actuating the wheel game simulation feature to simulate the wheel game being played and resulting in the wheel game outcome associated with the section assigned to the one or more unique numbers randomly drawn; and settle the wager based on the one or more unique numbers randomly drawn.

In some embodiments, the wheel game simulation feature comprises an electro-mechanically driven wheel configured to spin and come to a plurality of rest positions. Alternatively, the wheel game simulation feature may be a display device illustrating a virtual wheel game.

Some embodiments of the invention are directed to a method of implementing a bingo game system with a wheel game simulation feature having a wheel mounted for rotational motion having a circular face divided into a plurality of sections, wherein each section is associated with a wheel game outcome, one or more game stations and a game controller, the method including the steps of: receiving a wager through a data communication device; a processing device facilitating the steps of: assigning one or more unique numbers from a pool of bingo numbers to each section of a plurality of sections of the wheel, wherein each section is associated with a possible game outcome; randomly drawing numbers from the pool of bingo numbers; determining if the randomly drawn numbers include the one or more unique numbers assigned to one of the sections; responsive to the determination that the one or more unique numbers assigned to one of the sections has been randomly drawn, actuating the wheel game simulation feature to simulate the wheel game being played and resulting in the wheel game outcome associated with the section assigned to the one or more unique numbers randomly drawn; and settling the wager based on the one or more unique numbers randomly drawn.

In other embodiments, the wheel game simulation feature may be comprised of a series of illumination elements with at least one illumination element associated with each predetermined segment of the wheel device, the wheel is configured to illuminate the illumination element at a predetermined section associated with the winning bingo-game outcome to provide a representation associated with the bingo game outcome.

In some embodiments, both a winning and losing result may be displayed. In other embodiments, only the winning result is displayed for a player having a winning bingo card.

In some embodiments, the wheel game simulation feature is a display device providing a virtual wheel display.

In some embodiments of the aforementioned method, the one or more unique numbers comprises a first and second unique number from a finite pool of bingo numbers.

In some embodiments of the aforementioned method, the one or more unique numbers are preselected from the pool of bingo numbers. The one or more unique numbers may also be constant in that they remain the same.

### BRIEF DESCRIPTION OF THE DRAWINGS

Other advantages of the invention will be readily appreciated as the same becomes better understood by reference to the following detailed description when considered in connection with the accompanying drawings:

FIG. 1 is a schematic representation of an exemplary system for allowing a player to play exemplary gaming methods according to an embodiment of the invention;

FIG. 2a is a front view of a game station constructed and configured according to an embodiment of the invention;

FIG. 2b is a side view of a game system constructed and configured according to an embodiment of the invention;

FIG. 2c is a top view of a game station constructed and configured according to an embodiment of the invention;

FIG. 3 is a schematic view of a game controller that may be used with the system shown in FIG. 1;

FIG. 4 is a front view of the Big Six wheel which may be used in connection with a wheel game simulation feature constructed and configured according to the invention;

FIG. 5 is a front view of another wheel which may be used in connection with a wheel game simulation constructed and configured according to the invention;

FIG. 6 is a process flow chart illustrating an exemplary method of the invention;

FIG. 7 is a table illustrating an exemplary assignment of unique numbers to specific Big Six wheel game outcomes;

FIG. 8 is a table illustrating an exemplary assignment of unique numbers to wheel game outcomes;

FIG. 9 and FIG. 10 include graphical user interfaces illustrating game play on a system and using a method according to the invention; and

FIG. 11-13 illustrate various embodiments of the invention.

### DETAILED DESCRIPTION OF INVENTION

The exemplary embodiments herein relate to various systems and methods using in gaming applications. It should be understood that each of the methods and individual steps recited herein may be partially or wholly carried out in a variety of ways and/or systems, which may include, but are not limited to, an electronic gaming machine (EGM) for use by one or more players, a multiplayer platform which may include a player interface such as a touchscreen display and involve physical or virtual game symbols, a home computer and/or portable computing device, such as a tablet computer or mobile phone capable of communicating with a network or over the Internet, global telecommunication network or world wide web.

It should further be understood that the invention is directed to, among other things, methods of providing, conducting and resolving wagering games that include a sequence of controlled and concrete transformative events. Some of these events may involve communications between computing components, indicating preferences, placing wagers, debiting and awarding credits stored in an account, the generation of random data and results for one or more players, the application of randomly-generated data to resolve wagers, the pooling of all wagers placed, the determination of wager outcomes in accordance with preset outcome determining criteria, and the notification of such outcomes along with the designation of a portion of the wager pool for each player and simulated wheel game outcome. The generation of random data may be facilitated by computerized and/or physical implements, such as a random number generator. The transformative events may also include parsing of the data for comparative purposes with preset criteria to determine an outcome in the underlying bingo game.

Selected exemplary embodiments of the invention will now be explained with reference to the drawings. It will be apparent to those skilled in the art from this disclosure that the following description of exemplary embodiments of the invention is provided for illustration only and not for the purpose of limiting the invention as defined by the appended claims and their equivalents.

Referring to the figures, where like numerals indicate like or corresponding parts throughout the several views, systems and methods of the invention which are configured to cooperate with each other in order to provide a bingo game with a wheel simulation feature are described. In the exemplary embodiments the paradigm of a virtual or mechanical wheel-type game is described, like the Big Six wheel or any other rotatable wheel having a generally flat, circular face divided into sections with each section representing a game outcome. It should be understood that the wheel feature may be of any design or size, or other shapes may be used, in order to simulate the game outcome, that is, other visible, virtual or mechanical indicia can be employed, whether controlled mechanically, electro-mechanically or electronically.

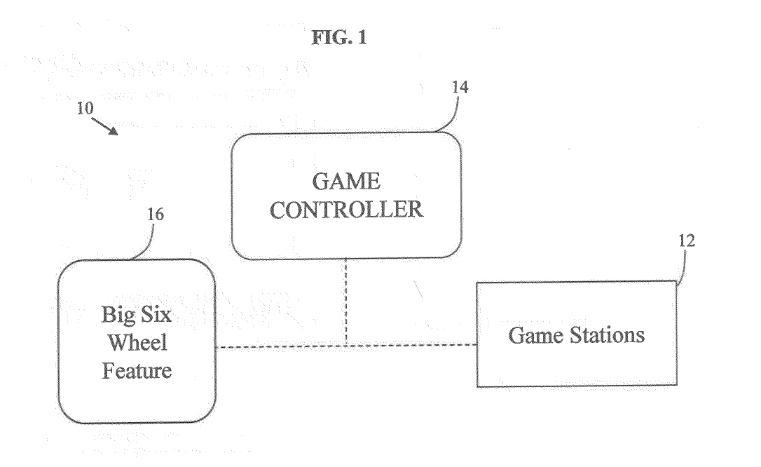

Referring to FIG. 1, a system 10 comprises one or more game stations 12, a game controller 14 and a wheel game simulation feature 16, which may be similar or the same as the wheel known as the Big Six or another type of wheel having sections for indicating game outcomes. These components may be housed in a unitary housing or remotely positioned with respect to each other, while remaining in communication. Communication between these components may be facilitated by data communication devices connected over a wired or wireless network, using any conventional digital communication devices that are appropriate based on the locations of the system components.

Wheel game simulation feature 16 generally includes a wheel or disc configured for rotational motion about an axis through its center which includes opposing first and second circular faces, with at least one of the first and second faces being made visible to players and including a plurality of circumferentially-arranged, radially-extending sections defined thereon. The sections may be defined by any distinguishing features, such as colors, symbols, graphics, numbers or lines for example, and may include award information thereon such as monetary amounts. The sections may be illuminated through illumination devices disposed within the wheel body or behind the wheel. The illumination may be used to simulate rotational motion, in that the illumination devices can sequentially illuminate to appear as if spinning before one section is illuminated to indicate the outcome. Wheel game simulation feature 16 may include a pointer, marker or other indicator apparatus which is attached to a housing or other support structure at a radially outer position relative to the face of the wheel but which “points” radially inward or is otherwise capable of identifying a single section of the wheel as being the winning section. In such an embodiment, the game outcome would be simulated and presented to players by having the wheel spin and then stop so that the pointer is in position relative to the wheel such that it points to the section on the face of the wheel corresponding to the outcome determined by the bingo results.

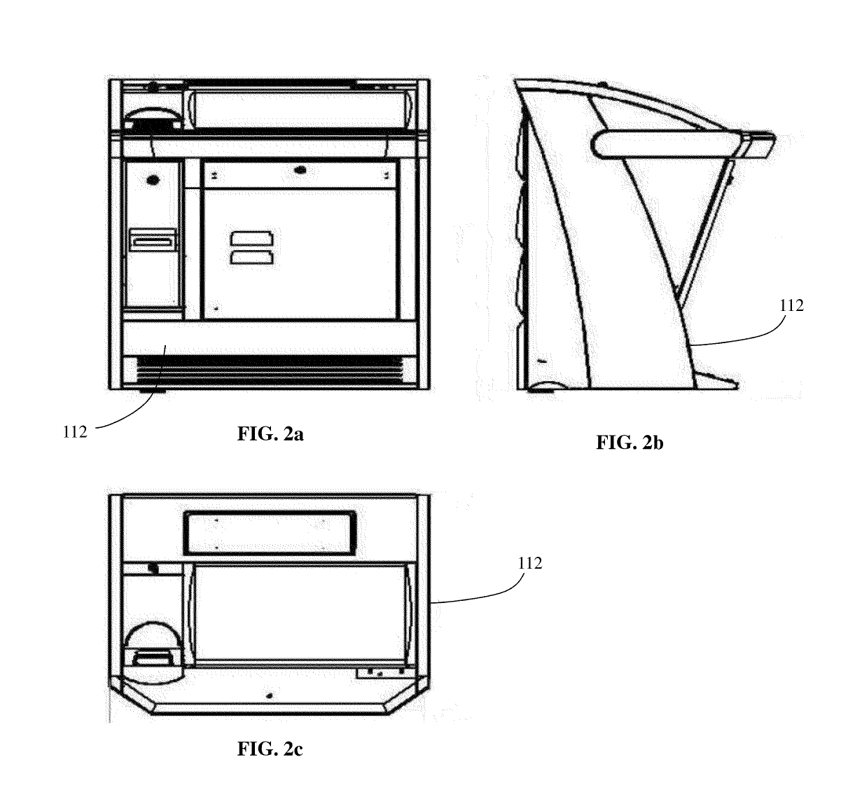

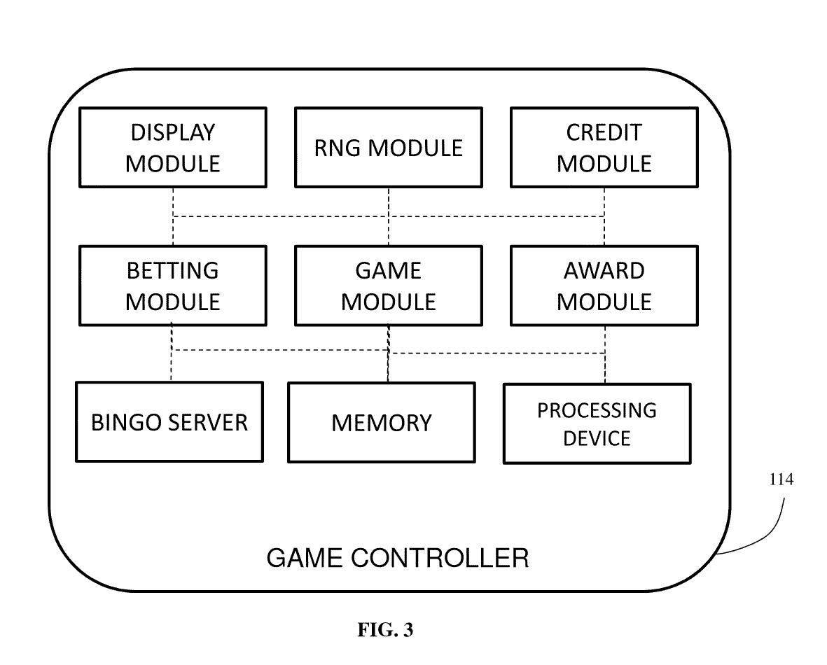

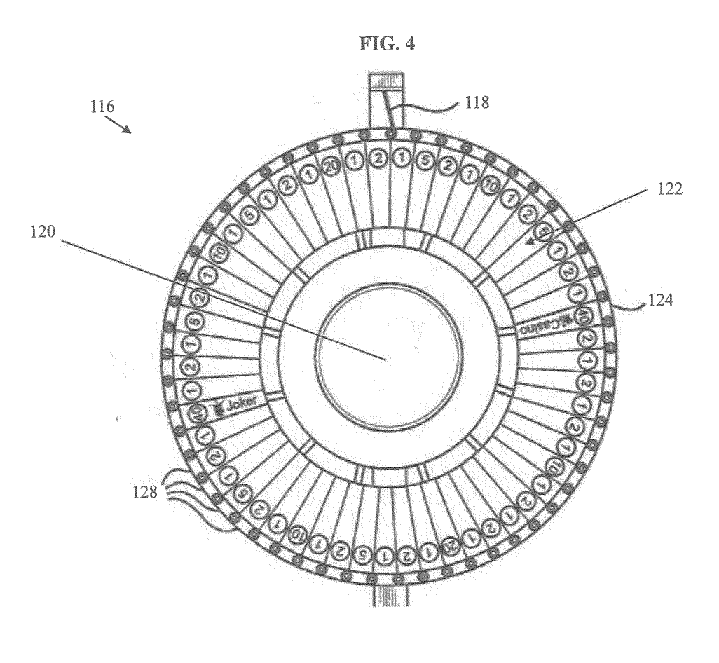

Each of the game stations 12 is used by the players in order to interact with the system and initiate game-play. Game stations 12 can take the form of player positions in a multi-player platform, electronic game machine cabinets or remote kiosks, but are not limited to such designs and may also be provided on smartphones, mobile computing devices, thin terminal devices, non-smartphone-type cellphones, tablets, laptops, or any other device configured to communicate within system 10. In some embodiments, game stations 12 include data communication devices, such as keypads and display devices, or touchscreen displays, bill or ticket acceptors and printers, etc. An exemplary game station 112 is shown in FIGS. 2a,b,c.

Game controller 14 may include one or more servers, random number generators, programs, databases, memory, data storage devices, data communication devices and data processing devices. Controller 14 is generally configured to manage the operation of bingo games as described herein by receiving wagers placed through game stations 12, providing virtual bingo cards or tickets to players, randomly drawn bingo numbers, determining if winning patterns are achieved and causing wheel game simulation feature 16 to simulate an outcome by causing the wheel operatively associated therewith to rotate and then come to a stop at an outcome (as defined by the section at which the wheel stops) which corresponds with the randomly drawn bingo numbers. All or some of the components of game controller 14 may reside together or be variously integrated into other components of system 10, including game stations 12 and wheel game simulation feature 16. Controller 14 may also include a security code secured keypad and or touchscreen device for use by authorized personnel.

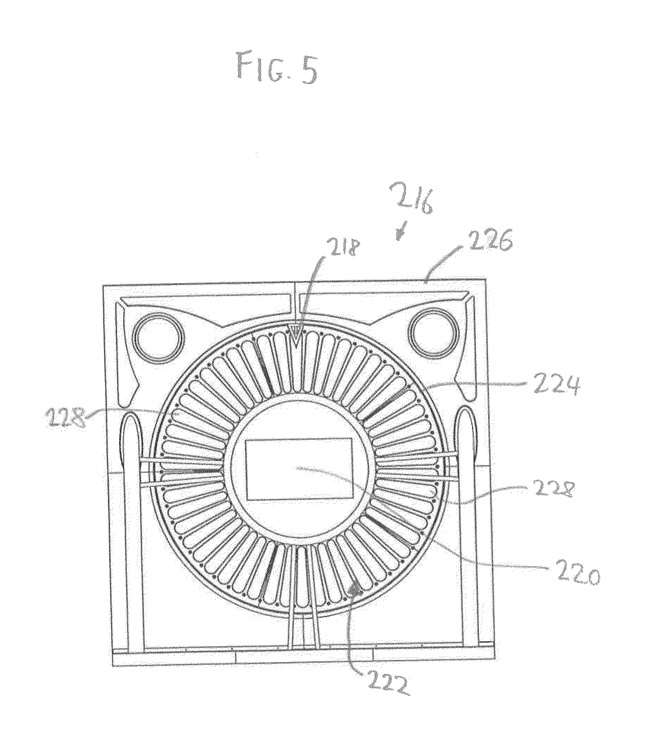

FIG. 3 illustrates some of the exemplary functionality expressed as modules in a game controller 114 which are facilitated by the aforementioned hardware and software components. Game controller 114 includes or is in communication with a display module, a random-number generator (RNG) module, a credit module, a betting module, a game module, and an award module, a bingo server, a processing device and memory. The display module controls the display device on stations 12 to display various images on the graphical interfaces as discussed herein below, such as a big six wheel layout, preferably by using computer graphics and/or image data stored in the memory. The credit module communicates with a player account server to manage the amount of player's credits available for use in system 10 and converts currency or tickets received in stations 12 to credit. The game module includes a game program for use in providing gaming methods in accordance with the invention. The game module may communicate with the bingo server to supply bingo cards or tickets to the stations 12 and communicate with the RNG module to obtain numbers from a pool of bingo numbers or balls. The betting module receives the player's wager information for resolving upon the conclusion of the game and the award module issues payouts for winning wagers.

Outcomes of the underlying bingo game are presented by simulating an instance of an actual wheel game as provided by wheel game simulation feature 16. Controller 14 determines the bingo game results based on randomly drawn numbers being compared to bingo tickets, which are then correlated to one of the possible outcomes on the wheel, which may include any number of possible outcomes.

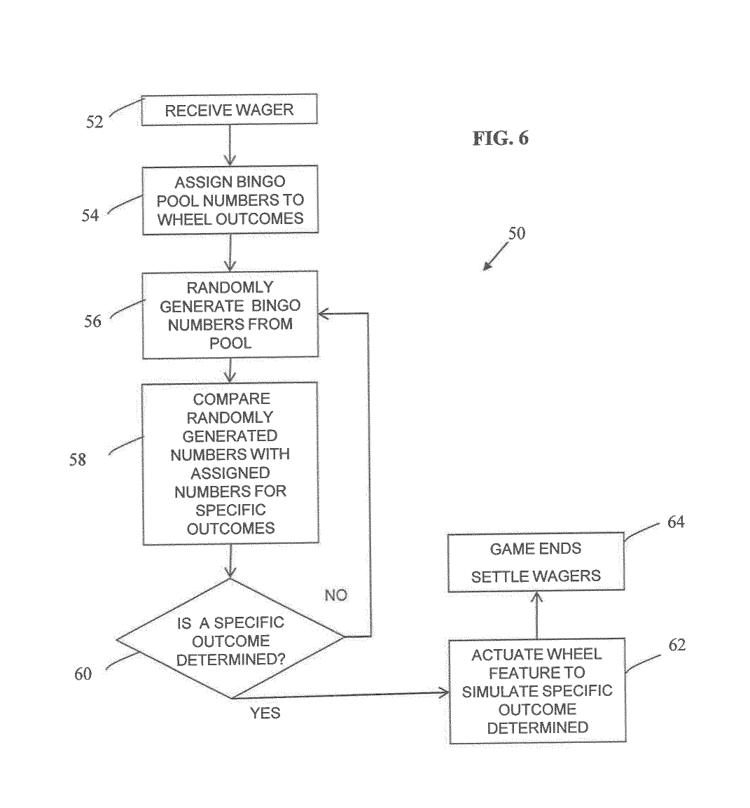

An exemplary wheel game simulation feature 116 is shown in FIG. 4, which includes an electromechanical wheel 124 configured for motor driven rotational motion via a motor (not shown) about the central axis 120 of wheel 124. In this embodiment, wheel 124 appears as a conventional Big Six wheel including fifty-four sections 128 defined on face 122. In operation, wheel 124 may be rotated by the motor upon all wagers being received through the game stations. Once the bingo outcome is generated and correlated to an outcome defined on face 122, wheel 124 will be made to come to a rest and stop under control of motor 120 so that the specific section 128 associated with a winning bingo-game outcome is indicated by marker 118 at the top of the wheel 124.

In some embodiments, big six wheel feature 116 may create suspense and game aesthetics by rotating wheel 124 at various speeds and durations of time, such as increasing and then decreasing speed until coming to a stop so that marker 118 may be positioned to the specific segment 128.

In some embodiments, a big six wheel feature of the invention can be either fully virtual, that is provided by a display device, or a partially virtual apparatus. In some embodiments, wheel 118 may include illuminating elements in each section 128 which illuminate to indicate a winning outcome. Additionally, it should be understood that a big six wheel is a non-limiting example of the invention, in that other electromechanical or virtual simulated features may be employed with the invention, such as a customized wheel or big wheel apparatus.

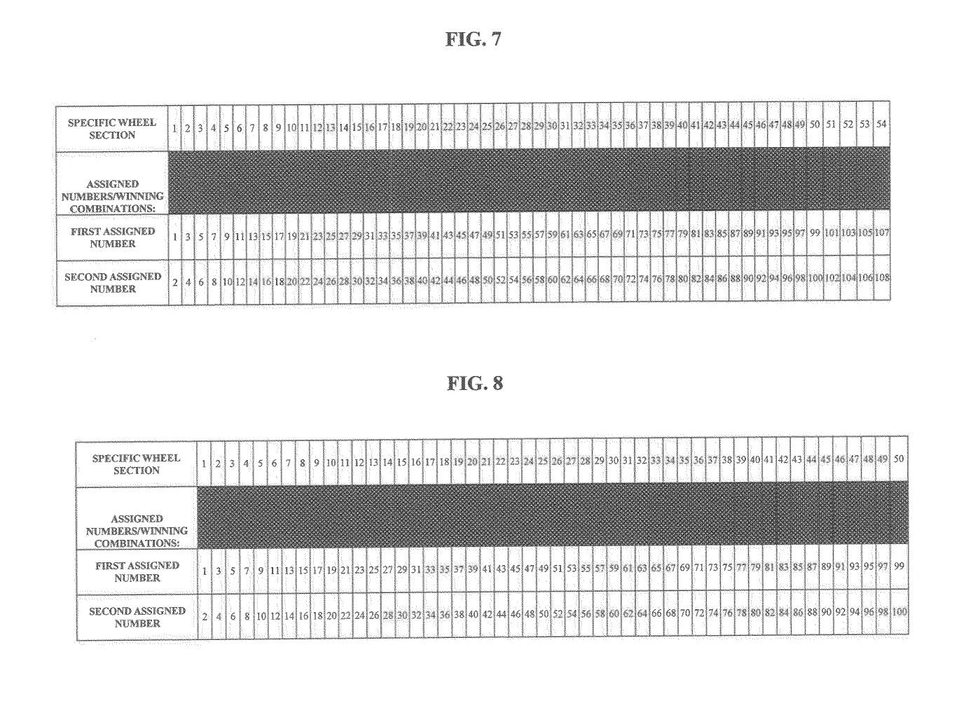

FIG. 5 illustrates another embodiment of the invention including wheel feature 216, which includes a rotating wheel 224 and fifty sections 228. A pointer 218 is attached to wheel housing 226 at a radially outer position relative to wheel 224. Housing 226 may include any components necessary to cause the rotational motion of the wheel, such as mechanical, electrical and electromechanical components like motors, gears and shafts, among other things, such as illumination devices and display devices.

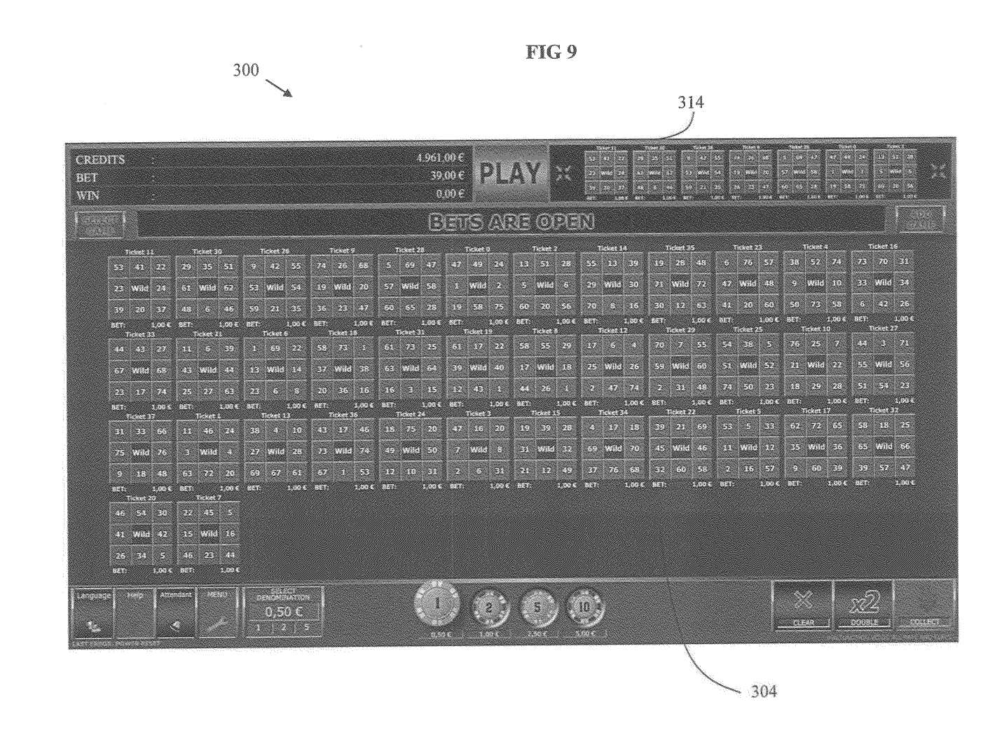

FIG. 6 shows an exemplary method 50 which may be utilized by system 10 to provide a bingo game with a wheel game simulation feature 16. In step 52, a wager is placed through a graphical user interface, which may be configured to resemble a wheel game layout, displayed on a game station 12. In some embodiments, controller 14 one or more numbers in a finite pool of numbers are assigned to each specific section of the wheel in step 54 with each section being associated with a specific game outcome in the wheel game. Controller 14 may either randomly assign one or more numbers in a finite pool of numbers with each section defined on the wheel, or the assignments of one or more numbers to specific sections or outcomes of the wheel may be preselected.

In step 56, bingo numbers from the finite pool are randomly generated via controller 14. In step 58 controller 14 determines if all of the one or more assigned numbers have been generated for any section of the wheel. As shown by step 60, if a section has not yet been determined, then controller 14 continues to generate bingo numbers. If a section has been determined, then controller 14 actuates wheel game simulation feature 16 in step 62 to simulate a wheel game and display the outcome of the wheel game by stopping the spinning of the wheel so that the corresponding determined section is identified as the game outcome. In step 64, the game ends once a section is determined and wagers are settled with losing wagers being collected while winning wagers being paid by adding credits at the appropriate station 12.

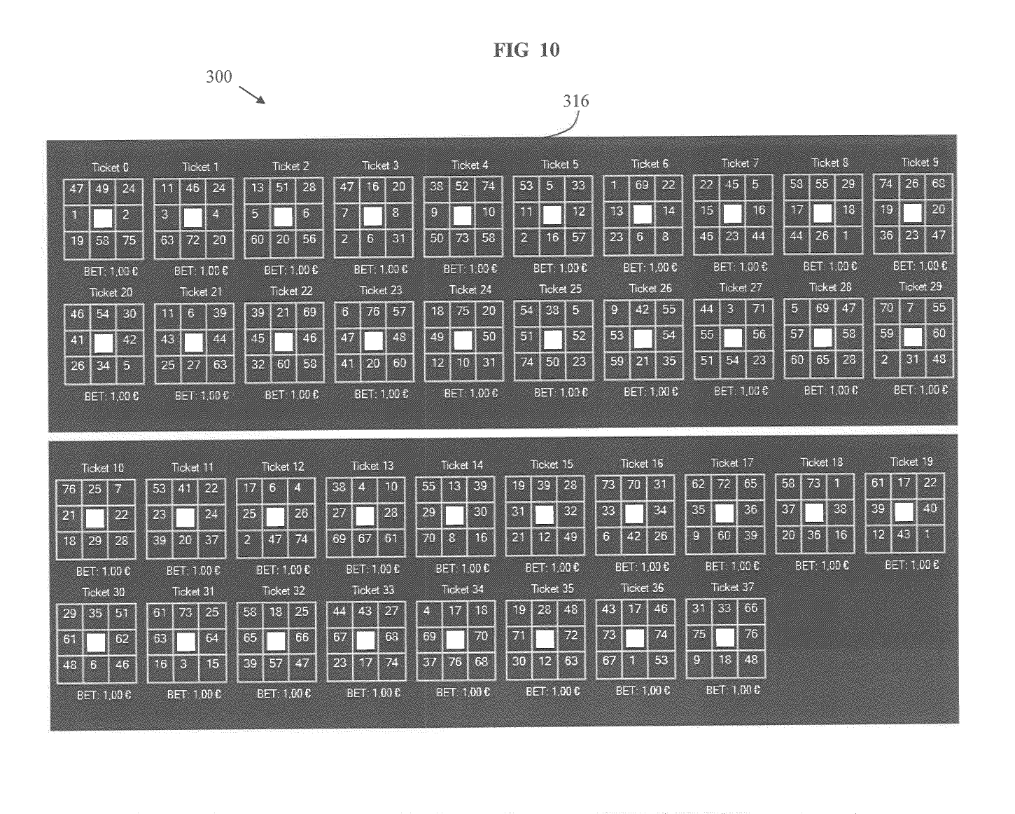

FIG. 7 illustrates an embodiment of method 50 in which each of the wheel outcomes for a wheel having fifty-four possible outcomes, such as wheel 124, the Big Six type wheel, of wheel outcome simulation feature 116 which includes fifty-four sections 128. Each section is associated with two unique numbers from a finite pool of numbers from one to one hundred and eight. Thus, if the randomly generated bingo numbers include the two unique numbers from one to one hundred and eight for any specific wheel outcome, the game ends and wheel feature 116 simulates the specific outcome associated with those two unique numbers by rotating and then stopping wheel 124 so that the section 128 associated with the specific outcome (such as a monetary value) is positioned adjacent to pointer 118. In this embodiment, the numbers one through one hundred and eight are sequentially ordered so that two numbers thereof are assigned to each specific possible section 128 on wheel 124. Each section of the fifty-four sections 128 is designated a number from one to fifty-four. For example, the preselected first and second unique numbers assigned to the specific wheel section 128 identified as section “6” are “11” and “12,” and preselected first and second unique numbers assigned to the wheel section 128 identified as section 52 are “103” and “104.” Thus, a player wagering on the bingo game or otherwise on a wheel outcome associated with section “6” in a game method 50 would win if bingo numbers “11” and “12” were randomly generated via controller 14 before the first and second unique numbers for another specific outcome had been generated. Wheel feature 116 would then simulate the wheel outcome by coming to a stop at which pointer 118 points to the section 128 of wheel 124 identified as section six. It should be understood that the pool of numbers may vary, which may also impact game play and duration until a winning outcome is determined. The size of the pool of numbers may also vary if there are a different number of possible outcomes.

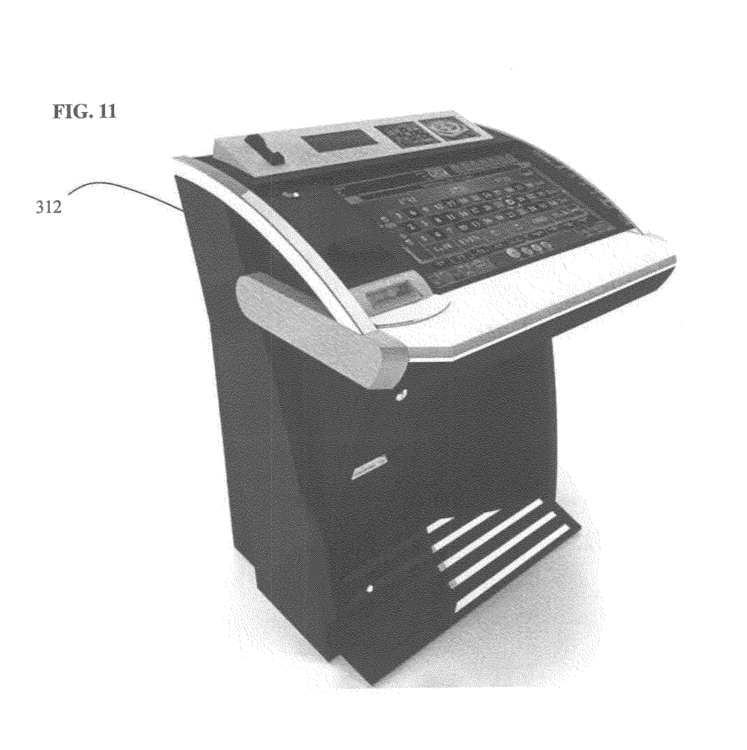

FIG. 8 illustrates another embodiment of method 50 in which each of the wheel outcomes for a wheel having fifty possible outcomes, such as wheel 224 of wheel outcome simulation feature 216 which includes fifty sections 228. Each section is associated with two unique numbers from a finite pool of numbers from one to one hundred. Thus, if the randomly generated bingo numbers include the two unique numbers from one to one hundred for any specific wheel outcome, the game ends and wheel feature 216 simulates the specific outcome associated with those two unique numbers by rotating and then stopping wheel 224 so that the section 228 associated with the specific outcome is positioned adjacent to pointer 218.

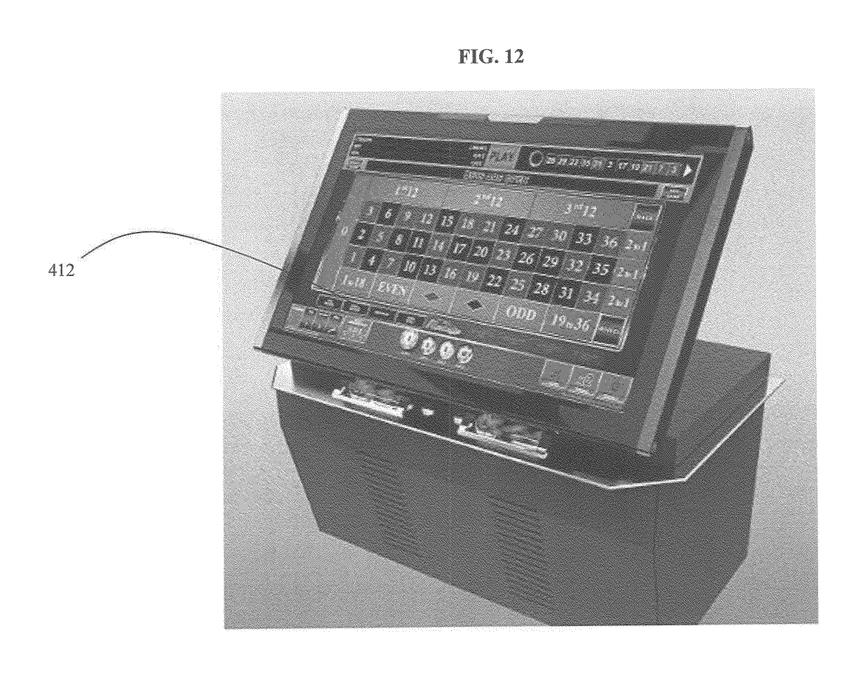

FIG. 9 and FIG. 10. provide graphical user interfaces or screens which may be displayed on game stations 12 having a touchscreen display in connection with another embodiment of the systems and methods of the invention generally referred to as game 300. It is envisioned that this embodiment would require two players as may be necessary. As such, wagers from at least two players must be received before game 300 will initiate.

Screens 314 illustrates bingo tickets generated by controller 14 (from ticket 0 to ticket 37 of the fifty tickets) on the user interface 304, and screen 316 presents the tickets in sequential order, with each having the first and second unique numbers, as shown in FIGS. 7 and 8, as the middle, horizontal line of each ticket For example, Ticket 26 includes first and second unique numbers 53, 54, which are assigned to section of a wheel feature 16 identified as section 27.

In other embodiments, the ticket may be a 5×5 grid, with one or more free spaces. The winning bingo patterns may be straight across, up or down, L-shaped, diagonal, four corners, full coverage, etc., or otherwise include conventional winning patterns for bingo.

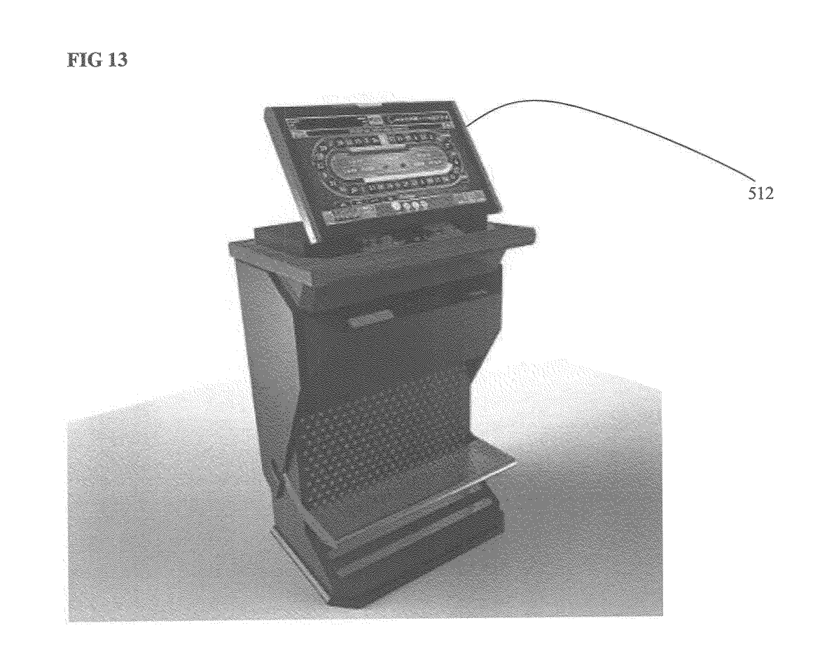

FIGS. 11 through 13 show multiple exemplary embodiments of the invention, including embodiments of game stations and wheel features, which illustrate various industrial applications of the invention, among other things.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. The terms used herein, such as modules like display module, betting module, award module, servers, etc., are for ease in describing and illustrating features and operations of the invention and are not to be considered limiting in any way. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Those skilled in the art will readily appreciate that the systems and methods described herein may be a standalone system or incorporated in an existing gaming system. The system of the invention may include various computer and network related software and hardware, such as programs, operating systems, memory storage devices, data input/output devices, data processors, servers with links to data communication systems, wireless or otherwise, and data transceiving terminals. It should also be understood that any method steps discussed herein, such as for example, steps involving the receiving or displaying of data, may further include or involve the transmission, receipt and processing of data through conventional hardware and/or software technology to effectuate the steps as described herein. Those skilled in the art will further appreciate that the precise types of software and hardware used are not vital to the full implementation of the methods of the invention so long as players and operators thereof are provided with useful access thereto, either through a mobile device, gaming platform, or other computing platform via a local network or global telecommunication network.

Although specific features of various embodiments of the invention may be shown in some drawings and not in others, this is for convenience only. In accordance with the principles of the invention, any feature of a drawing may be referenced and/or claimed in combination with any feature of any other drawing.

While exemplary systems and methods in accordance with the invention have been described herein and in the accompanying materials, it should also be understood that the foregoing along with the accompanying materials are illustrative of a few particular embodiments as well as principles of the invention, and that various modifications can be made by those skilled in the art without departing from the scope and spirit of the invention. Therefore, the described embodiments should not be considered as limiting of the invention in any way. Accordingly, the invention embraces alternatives, modifications and variations which fall within the spirit and scope of the invention as set forth in the claims, including equivalents thereto.

What is claimed is:

1. A bingo game system having a wheel game simulation feature comprising:
one or more game stations, each playing station configured to accept a wager;
a wheel game simulation feature including a wheel mounted for rotational motion having a circular face divided into a plurality of sections, wherein each section is associated with a wheel game outcome; and
a game controller configured to:
a) receive a wager through the one or more game stations;
b) assign one or more unique numbers from a pool of bingo numbers to each section of the plurality of sections of the wheel, wherein each section is associated with a possible game outcome;
c) randomly draw numbers from the pool of bingo numbers;
d) determine if the randomly drawn numbers include the one or more unique numbers assigned to a section;
e) responsive to the determination that the one or more unique numbers assigned to a section has been randomly drawn, actuating the wheel game simulation feature to simulate the wheel game being played and resulting in the wheel game outcome associated with the section assigned to the one or more unique numbers randomly drawn; and
f) settle the wager based on the one or more unique numbers randomly drawn.

2. The system as recited in claim 1, wherein the wheel game simulation feature comprises an electro-mechanically driven wheel configured to spin and come to a plurality of rest positions.

3. The system as recited in claim 1, wherein the wheel game simulation feature is a display device.

4. A method of implementing a bingo game system with a wheel game simulation feature having a wheel mounted for rotational motion having a circular face divided into a plurality of sections, wherein each section is associated with a wheel game outcome, one or more game stations and a game controller, the method including the steps of:
a) receiving a wager through a data communication device;
b) a processing device facilitating the steps of:
i) assigning one or more unique numbers from a pool of bingo numbers to each section of a plurality of sections of the wheel, wherein each section is associated with a possible game outcome;
ii) randomly drawing numbers from the pool of bingo numbers;
iii) determining if the randomly drawn numbers include the one or more unique numbers assigned to one of the sections;
iv) responsive to the determination that the one or more unique numbers assigned to one of the sections has been randomly drawn, actuating the wheel game simulation feature to simulate the wheel game being played and resulting in the wheel game outcome associated with the section assigned to the one or more unique numbers randomly drawn; and
v) settling the wager based on the one or more unique numbers randomly drawn.

5. The method according to claim 4, wherein the one or more unique numbers comprises a first and second unique number from a finite pool of bingo numbers.

6. The method according to claim 4, wherein the one or more unique numbers are preselected from the pool of bingo numbers.

7. The method according to claim 6, wherein the one or more unique numbers remain the same for each game.
